(19) United States
(12) Patent Application Publication
(10) Pub. No.: US 2025/0252318 A1
(43) Pub. Date: Aug. 7, 2025

(54) TRAINING NEURAL NETWORK THROUGH DENSE-CONNECTION BASED KNOWLEDGE DISTILLATION

(71) Applicant: Intel Corporation, Santa Clara, CA (US)

(72) Inventors: Anbang Yao, Beijing (CN); Xiaolong Liu, Beijing (CN); Ming Lu, Beijing (CN); Shandong Wang, Beijing (CN); Yurong Chen, Beijing (CN)

(73) Assignee: Intel Corporation, Santa Clara, CA (US)

(21) Appl. No.: 18/856,970

(22) PCT Filed: May 16, 2022
(86) PCT No.: PCT/CN2022/093120

§ 371 Date: Oct. 15, 2024

(51) Int. Cl. G06N 3/096; G06N 3/045

(52) U.S. Cl. CPC G06N 3/096; G06N 3/045

(57) ABSTRACT

A neural network can be trained through knowledge distillation. A support neural network is generated based on a target neural network. The support neural network is a teacher model, and the target neural network is a student model. The support neural network may have same layers as the target neural networks. Some or all layers of the support neural network may be connected to facilitate data transfer between these layers. The support neural network and target neural network are merged into a merged network. The merged network is trained. At least one layer in the support neural network is connected to a layer in the target neural network to facilitate data transfer from the target neural network to the support neural network during the training. After the training, the target neural network is separated from the merged network and can be used to perform machine learning tasks.

### CROSS REFERENCE TO PRIOR APPLICATION

This application is a national stage application under 35 U.S.C. § 371 of International Application No. PCT/CN2022/093120, filed May 16, 2022, titled “TRAINING NEURAL NETWORK THROUGH DENSE-CONNECTION BASED KNOWLEDGE DISTILLATION,” which is incorporated herein by reference in its entirety.

### TECHNICAL FIELD

This disclosure relates generally to neural networks, and more specifically, to training deep neural networks (DNNs) through dense-connection based knowledge distillation.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as hundreds of millions of weight operand weights to be stored for classification or detection. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example layer structure of a DNN, in accordance with various embodiments.

FIG. 2 is a block diagram of a DNN system, in accordance with various embodiments.

FIG. 3 illustrates an example teacher network formed based on a student network, in accordance with various embodiments.

FIG. 4 illustrates merging the student network with the teacher network, in accordance with various embodiments.

FIG. 5 illustrates training a merged network, in accordance with various embodiments.

FIG. 6 illustrates a deep learning (DL) environment, in accordance with various embodiments.

FIG. 7 is a flowchart showing a method of training a DNN through dense-connection based knowledge distillation, in accordance with various embodiments.

FIG. 8 is a block diagram of an example computing device, in accordance with various embodiments.

### DETAILED DESCRIPTION

### Overview

DNNs are widely used in the domains of computer vision, speech recognition, image, and video processing mainly due to their ability to achieve beyond human-level accuracy. However, the improvements in accuracy come at the expense of significant computation cost. The underlying DNNs have extremely high computing demands as each input requires at least hundreds of millions of MAC operations as well as hundreds of millions of weight operand weights to be processed for classification or detection. Energy constrained mobile systems and embedded systems, where energy and area budgets are extremely limited, often use area and energy efficient DNN accelerators as the underlying hardware for executing ML applications.

Knowledge distillation is one of the solutions that provides a teacher-student training framework to train a compact, computationally efficient DNN model having improved predication accuracy via a, compared to the standard training. Most knowledge distillation techniques require two training stages. The first training stage is to train the teacher network. The second training stage is to use the pretrained teacher network to train a student network. In the second stage, the training of the student network is guided by predictions made by the teacher model. For instance, the internal parameters (e.g., weights) of one or more layers of the student network are adjusted so that the features output from these layers can match the features output from corresponding layers of the teacher network. The student network usually has a smaller size than the teacher network and therefore, requires less computational resources for inference. Some other knowledge distillation techniques may be a one-stage solution and can collaboratively train the teacher network and student network.

However, these knowledge distillation techniques have several drawbacks. For instance, these knowledge distillation techniques rely on a well-defined teacher network for training any given student network. Such a teacher network may not be available in certain applications. Also, because these knowledge distillation techniques require additionally training a teacher model that is more complicated, the training cost can be significantly higher than the cost for training a single student network. In certain scenarios, the training cost can be 3 to 20 times higher. Further, these knowledge distillation techniques usually require tuning of hyperparameters for training the student network. Examples of such hyperparameters include learning rate, temperature, weighing coefficient to different loss function terms, and so on. Such tuning sometimes must be manual. The requirement for the tuning can cause additional consumption of computational resources, human resources, energy, and time. Therefore, improved techniques for knowledge distillation are needed.

Embodiments of the present disclosure may improve on at least some of the challenges and issues described above by providing methods and apparatus that facilitate dense-connection based knowledge distillation. In various embodiments of the present disclosure, a teacher network is generated based on the structure of a student network. In an example, every layer (“teacher layer”) of a part of or the whole teacher network is generated based on a layer (“student layer”) of the student network. The structure of a teacher layer may mirror the structure of the corresponding student layer. For instance, the teacher layer may include a same number of processing elements as the student layer, and the processing elements may be arranged in the same way in the two layers. The generation of the teacher network also includes formation of connections (“internal connections”) within the teacher network. An internal connection connects from a layer of the teacher network to another layer of the teacher network.

After the teacher network is formed, the teacher network and student network are merged, which forms a merged network. The merging of the two networks may include forming connections (cross-network connections) between the two networks. A cross-network connection connects from a layer of the teacher network to a layer of the student network. A connection (e.g., an internal connection or a cross-network connection) can facilitate data transfer (e.g., transfer of features) between two layers. Further, the merged network is trained. For instance, training samples are provided to the merged network, e.g., to both the teacher network and the student network. Each network provides an output. The outputs and ground-truth labels of the training samples can be used to adjust parameters of the merged network based on a loss function. After the merged network is trained, the student network can be separated from the teacher network and be used in one or more applications.

Different from conventional knowledge distillation techniques, the present disclosure provides a technique that facilitate knowledge distillation through connections in a network that merges the teacher network and student network. Such a knowledge distillation technique is adaptable to train DNNs for various applications, such as image classification, face recognition, action recognition, person re-identification, machine translation and speech recognition, and so on. Also, compared with conventional knowledge distillation techniques, the technique in the present disclosure is more friendly to user. It enables the user to take advantage of the student network to develop the teacher network. The use does not have to define the teacher network beforehand. Further, it allows the user to train the student network and teacher network together, e.g., through one training process.

Moreover, the present disclosure provides a better accuracy-efficiency tradeoff. As the student network and teacher network are trained together, the training cost can be significantly reduced. For certain applications, the training cost can be several times less than the training cost of conventional knowledge distillation techniques. The reduction in training cost does not sacrifice the accuracy of the network. Rather, the accuracy of networks trained by the technique in the present disclosure can be better than the accuracy of networks trained by many conventional knowledge distillation techniques. With the present disclosure, computationally intensive DNNs can be converted to more lightweight DNNs with similar accuracy. The present disclosure can also enable replacement of deep, sequential processing with parallel, distributed processing. This type of structural conversion can facilitate acceleration of DNN training and inference using general-purpose processors (GPPs), such as multi-core CPUs (central processing units) and GPUs (graphics processing units). Further benefit can be realized given the flexibility of custom hardware by taking advantage of additional approximation.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN Layer Structure

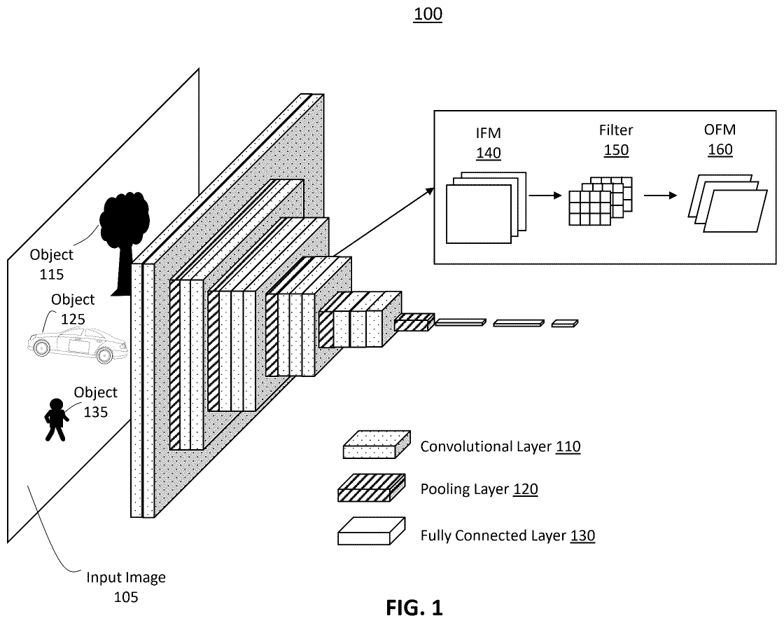

FIG. 1 illustrates an example layer structure of a DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiment of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers.

The convolutional layers 110 summarize the presence of features in the input image 105. In the embodiment of FIG. 1, the first layer of the DNN 100 is a convolutional layer 110. The convolutional layers 110 function as feature extractors. A convolutional layer 110 can receive an input and outputs features extracted from the input. In an example, a convolutional layer 110 performs a convolution to an IFM (input feature map) 140 by using a filter 150, generates an OFM (output feature map) 160 from the convolution, and passes the OFM 160 to the next layer in the sequence. The IFM 140 may include a plurality of IFM matrices. The filter 150 may include a plurality of weight matrices. The OFM 160 may include a plurality of OFM matrices. For the first convolutional layer 110, which is also the first layer of the DNN 100, the IFM 140 is the input image 105. For the other convolutional layers, the IFM 140 may be an output of another convolutional layer 110 or an output of a pooling layer 120.

A convolution may be a linear operation that involves the multiplication of a weight operand in the filter 150 with a weight operand-sized patch of the IFM 140. A weight operand may be a weight matrix in the filter 150, such as a 2-dimensional array of weights, where the weights are arranged in columns and rows. Weights can be initialized and updated by backpropagation using gradient descent. The magnitudes of the weights can indicate importance of the filter 150 in extracting features from the IFM 140. A weight operand can be smaller than the IFM 140. The multiplication can be a element-wise multiplication between the weight operand-sized patch of the IFM 140 and the corresponding weight operand, which is then summed, always resulting in a single value. Because it results in a single value, the operation is often referred to as the “scalar product.”

In some embodiments, using a weight operand smaller than the IFM 140 is intentional as it allows the same weight operand (set of weights) to be multiplied by the IFM 140 multiple times at different points on the IFM 140. Specifically, the weight operand is applied systematically to each overlapping part or weight operand-sized patch of the IFM 140, left to right, top to bottom. The result from multiplying the weight operand with the IFM 140 one time is a single value. As the weight operand is applied multiple times to the IFM 140, the multiplication result is a two-dimensional array of output values that represent a weight operanding of the IFM 140. As such, the 2-dimensional output array from this operation is referred to a “feature map.”

In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the weight operands. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new weight operands and generates a new feature map. The new feature map may also be normalized and resized. The new feature map can be weight operanded again by a further subsequent convolutional layer 110, and so on.

In some embodiments, a convolutional layer 110 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolutional layers 110: a preceding convolutional layer 110 (the convolutional layer 110 preceding the pooling layer 120 in the sequence of layers) and a subsequent convolutional layer 110 (the convolutional layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolutional layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolutional layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiment of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example DNN System

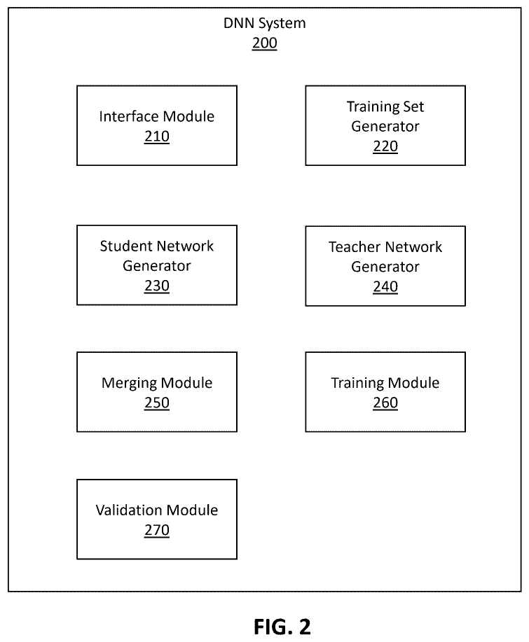

FIG. 2 is a block diagram of a DNN system 200, in accordance with various embodiments. The DNN system 200 trains DNNs by using dense-connection based knowledge distillation. A DNN can be used to perform one or more machine learning tasks. A machine learning task is a task of making an inference. The inference is a process of running available data into the DNN to generate an output, and the output provides a solution to a problem or question that is being asked. An example of the output is one or more numerical scores that can indicate a probability of an object in an image belonging to a category. The DNN system 200 can train DNNs that can be used to solve various problems, such as image classification, learning relationships between biological cells (e.g., DNA, proteins, etc.), control behaviors for devices (e.g., robots, machines, etc.), and so on.

The DNN system 200 includes an interface module 210, a training set generator 220, a student network generator 230, a teacher network generator 240, a merging module 250, a training module 260, and a validation module 270. In other embodiments, alternative configurations, different or additional components may be included in the DNN system 200. Further, functionality attributed to a component of the DNN system 200 may be accomplished by a different component included in the DNN system 200 or by a different system.

The interface module 210 facilitates communications of the DNN system 200 with other systems. For example, the interface module 210 establishes communications between the DNN system 200 with an external database to receive data that can be used to train DNNs or data that can be input into DNNs to perform machine learning tasks. As another example, the interface module 210 supports the DNN system 200 to distribute DNNs to other systems, e.g., computing devices configured to apply DNNs to perform tasks. The computing devices may be an edge device, a client device, and so on.

The training set generator 220 forms training datasets that will be used to train DNNs. A training dataset includes training samples and ground-truth labels. The training dataset may include one or more ground-truth labels for each training sample. A ground-truth label of a training sample may be a known or verified label that answers the problem or question that the DNN will be used to answer. In an example where a DNN is trained to recognize objects in images, the training dataset includes training images and ground-truth labels that indicate classifications of objects in the training images. A ground-truth label in the example may be a number that indicates a probability that an object belongs to a class. The object may be associated with other ground-truth labels that indicate probabilities that the object belongs to other classes.

In some embodiments, the training set generator 220 may also form validation datasets for validating performance of trained DNNs by the validation module 270. A validation dataset may include validation samples and ground-truth labels of the validation samples. The validation dataset for a DNN may include different samples from the training dataset used for training the DNN. In an embodiment, a part of a training dataset may be used to initially train a DNN, and the rest of the training dataset may be held back as a validation subset used by the validation module 270 to validate performance of the trained DNN. The portion of the training dataset not including the validation subset may be used to train the DNN.

The student network generator 230 generates student networks. A student network is a DNN that after trained, can be used to perform machine learning tasks. The student network generator 230 may generates a student network based on parameters that define the architecture of a DNN. Examples of the parameters include the number of layers, types of layers, sequence of layers, number of processing elements (PEs) in a layer, types of PEs, arrangement of PEs (e.g., interconnections between PEs, number of columns in a PE array, number of rows in a PE array, etc.) in a layer, activation function, pooling function, or other types of parameters. A processing element performs MAC operations.

In some embodiments, the student network generator 230 determines some or all of the parameters, e.g., based on the problem or question to be answered by the DNN, resource available for training, resources available for inference, some other factors that may be critical to the architecture of the DNN, or some combination thereof. In other embodiments, the student network generator 230 may receive some or all of the parameters from a different system (e.g., from a computing device that will run the DNN for inference, a system managing such computing devices, etc.) or from a user (e.g., through a user interface that allows the user to provide information of the DNN).

The architecture of a DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as rectified liner unit (ReLU) layers, pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolutional layers. A fully connected layer involves weights, biases, and neurons. It connects neurons in one layer to neurons in another layer. It is used to classify images between different category by training. An example DNN is the DNN 100 described above in conjunction with FIG. 1.

The teacher network generator 240 generates teacher networks based on student networks. Teach networks will be used for training the student networks through knowledge distillation. A teacher network may be a DNN. In some embodiments, the teacher network generator 240 determines a structure of a teacher network based on the structure of a student network. For instance, the teacher network generator 240 may generate a teach network including the same number and/or types of layers as the student network. The arrangement of the layers in the teacher network (“teacher layers”) can be the same as the arrangement of the layers in the student network (“student layers”). Also, for an individual teacher layer, the teacher network generator 240 may design the teacher layer based on a corresponding student layer. The teacher network generator 240 may make the teacher layer mirror the student layer. For instance, the teacher layer can have the same number and/or types of PEs as the student layer. The arrangement of the PEs can also be the same in the two layers. As the teacher network can be generated automatically based on the student network, well-defined teacher networks do not have to be available beforehand. Also, the generation of the teacher network does not introduce additional parameters. The dimensions of IFM and OFM of the teacher layers and student layers can be the same, which can facilitate feature transfer and knowledge distillation during the training process, which are described below.

The teacher network generator 240 also generates internal connections within the teacher network. An internal connection may connect two teacher layers, e.g., from a first teacher layer to a second teacher layer. The second teacher layer may be arranged in after the first layer in the teacher network. The internal connection facilitates data transfer between the two teacher layers. For instance, the first layer can send features (e.g., OFM 160) to the second layer through the internal connection. The second layer receives the features and can aggregate the features from the first layer with features generated in the second layer to output aggregated features. An internal connection may be bi-directional, e.g., the second layer can also send data to the first layer.

In some embodiments, the teacher network generator 240 form multiple internal connections for a teacher layer. In an example, the teacher network generator 240 identifies one or more layers that is subsequent to a target layer. For each respective layer of the one or more layers, the teacher network generator 240 forms an internal connection from the target layer to the respective layer. The one or more layers may be of the same type as the target layer. For instance, the one or more layers and the target layer are convolutional layers. A teacher layer may receive data (e.g., features) from multiple other teacher layers and can aggregate the data with data generated in the teacher layer itself.

The merging module 250 merges a student network and a teacher network, e.g., a teacher network generated based on the student network. The merging module 250 may receive the student network from the student network generator 230 and receive the teacher network from the teacher network generator 240. In some embodiments, the merging module 250 build cross-network connections between the student network and the teacher network during the merging process. Data can be transferred between the two networks through the cross-network connections. In an example, the merging module 250 build cross-network connections from the student network to the teacher network. A cross-network connection can connect from a student layer to a teacher layer and allow the student layer to send data to the teacher layer. In other embodiments, a cross-network connection may be bi-directional, e.g., the teacher layer can also send data to the student layer.

The merging module 250 may form multiple cross-network connections for a student layer. In an example, the teacher network generator 240 identifies one or more teacher layers for the student layer. The one or more teacher layers may include a teacher layer that corresponds to the student layer (e.g., the teacher layer that is generated based on the student layer, the teacher layer's position in the teacher network matching the student layer's position in the student network, etc.). The one or more teacher layers may also include additional teacher layers that are subsequent to the teacher layer in the teacher network. In an example, for a student layer, the teacher network generator 240 identifies the corresponding teacher layer and one or more other teacher layers subsequent to the corresponding teacher layer. The identified teacher layers may be of the same type, e.g., they are all convolutional layers. Also, the identified teacher layers may be of a same type as the student layer. For each identified teacher layer, the merging module 250 can form a cross-network connection from the student layer to the identified teacher layer.

A teacher layer, which receives data (e.g., features) from a student layer, can aggregate the data with data generated in the teacher layer itself. A teacher layer may be connected to multiple student layers and receive data from some or all of these student layers. A student layer may be connected to multiple teacher layers and send data to some or all of these teacher layers. The merging of the two networks results in a merged network that can be trained as a whole, e.g., like training a single network. As the student network is merged with the teacher network during the training, the two networks can share the “knowledge” they learn during the training with each other. The feature similarity between the teacher network and the student network can be enhanced due to dense backward gradient flows from the teacher network to the student network. Knowledge learned by the teacher network can be transferred to the student network by dense teacher-to-student gradient propagations during the training of the merged model. The merging can facilitate knowledge distillation without requiring two training processes that many other knowledge distillation techniques require (e.g., one for training the teacher network, and another one for training the student network). Also, the need to design feature distillation losses and to tune weighting factors to balance loss terms can be avoided.

The training module 260 trains DNNs, such as merged networks provided by the merging module 250. The training module 260 may also receive training datasets from the training set generator 220. The training module 260 may also determine hyperparameters for the training process. Hyperparameters may be different from parameters inside the network (e.g., weights). In some embodiments, the hyperparameters include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the parameters inside the network. An epoch may include one or more batches. The number of epochs may be 10, 100, 500, 1000, or even larger.

The training module 260 sends training samples in a training dataset to a merged network, e.g., the training module 260 inputs the training samples into both the teacher network and the student network. The training module 260 modifies the parameters inside the merged network (e.g., weights of convolutional layers of the teacher network, the student network, or both) to minimize the error between labels of the training samples that are generated by the merged network (“generated labels”) and the ground-truth labels in the data set. The generate labels may include one or more labels generated by the student network and one or more labels generated by the teacher network. The training module 260 may use a loss function, e.g., a cross-entropy loss function, to minimize the error.

The training module 260 may stop adjusting the parameters in the merged network after a threshold condition is met. The threshold condition may be that a predetermined number of epochs are done, a target performance (e.g., an accuracy) of the merged, student, or teacher network is met, or other types of conditions. The network having the updated parameters is referred to as a trained network. After the merged network is trained, the training module 260 separate the student network from the teacher network, e.g., by removing the cross-network connections. The student network can be used to handle machine learning tasks. In some embodiments, the student network, or parameters of the student network, may be sent to another system or device (e.g., an edge device, a client device, etc.) for inference.

The validation module 270 verifies performance (e.g., accuracy) of trained DNNs, such as trained student networks that are separated from their corresponding teacher networks. The validation module 270 may determine an accuracy of a trained student network and determines whether the accuracy meets a threshold (e.g., a requirement for model accuracy). In response to determining that the accuracy of the student network meets the threshold, the validation module 270 may deploy the student network to another system or device, e.g., through the interface module 210. In some embodiments, the validation module 270 may also verify performance of merged networks or teacher networks. For instance, the validation module 270 determines whether an accuracy of a merged network meets a threshold. In response to determining that the accuracy does not meet the threshold, the validation module 270 may instruct the training module 260 to further train the merged network. In response to determining that the accuracy meets the threshold, the validation module 270 may notify the training module 260 that the merged network has been sufficiently trained or instruct the training module 260 to separate the student network from the teacher network.

In some embodiments, the validation module 270 inputs samples in a validation dataset into the DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 270 determines may determine an accuracy score measuring the precision, recall, or a combination of precision and recall of the DNN. The validation module 270 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

Example Teacher Network Formed from Student Network

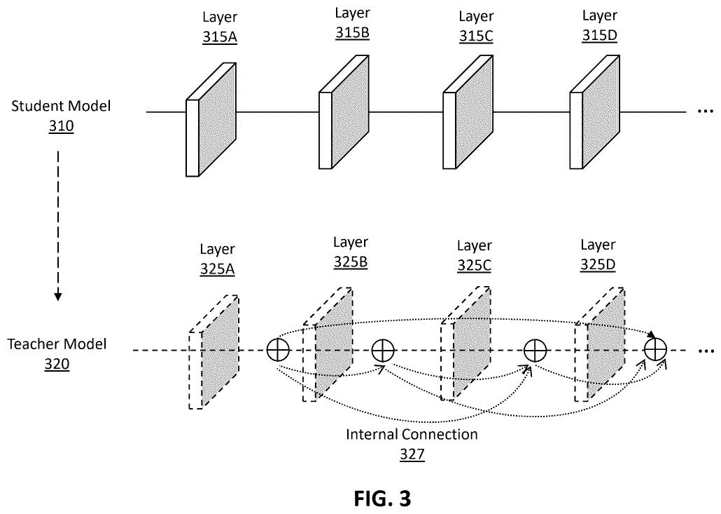

FIG. 3 illustrates an example teacher network 320 formed based on a student network 310, in accordance with various embodiments. The student network 310 may be provided by the student network generator 230. The formation of the teacher network 320 may be done by the teacher network generator 240. For purpose of simplicity and illustration, the student network 310 includes four layers 315A-315D (collectively referred to as “student layers 315” or “student layer 315”), and the teacher network 320 includes four layers 325A-325D (collectively referred to as “teacher layers 325” or “teacher layer 325”). The student layers 315 and teacher layers 325 may be convolutional layers, self-attention layers, linear layers, or some combination thereof. In other embodiments, the student network 310 or the teacher network 320 may include more, fewer, or different layers. For instance, the student network 310 or the teacher network 320 may include additional layers arranged between, before, or after the layers shown in FIG. 3.

In the embodiments of FIG. 3, the teacher layers 325 align with the student layers 315. Each teacher layer 325 corresponds to a student layer 315. For instance, the teacher layer 325A corresponds to the student layer 315A, the teacher layer 325B corresponds to the student layer 315B, the teacher layer 325C corresponds to the student layer 315C, and the teacher layer 325D corresponds to the student layer 315D. A teacher layer 325 may be generated based on its corresponding student layer 315. For instance, the teacher layer 325 may have same structural units as the student layer 315. The arrangement of the structure units in the teacher layer 325 can be the same as the arrangement in the student layer 315. The structure units may include PEs that perform MAC operations, data storage units (e.g., memory, register file, etc.), or other types of units.

Internal connections 327 (individually referred to as “internal connection 327”) between teacher layers 325 are added to the teacher network 320 to form a densely connected architecture. A teacher layer 325 may be connected to each of the other teacher layers 325 in the teacher network 320. For purpose of illustration, the teacher network 320 includes six internal connections 327: one from the teacher layer 325A to the teacher layer 325B, one from the teacher layer 325A to the teacher layer 325C, one from the teacher layer 325A to the teacher layer 325D, one from the layer 325B to the layer 325C, one from the teacher layer 325B to the teacher layer 325D, one from the teacher layer 325C to the teacher layer 325D. In other embodiments, the teacher network 320 may have more, fewer, or different internal connections.

An internal connection 327 facilitates data transfer between the two teacher layers 325: a preceding teacher layer 325 and a subsequent teacher layer 325, where the subsequent teacher layer 325 is a layer that is arranged after the preceding teacher layer 325 in the teacher network 320. There may be zero, one, or more other teacher layers 325 between the preceding teacher layer 325 and the subsequent teacher layer 325. Alternatively, an internal connection 327 can be bi-directional so that data can be transferred from the preceding teacher layer 325 to a subsequent teacher layer 325, or from the subsequent teacher layer 325 to the preceding teacher layer 325.

A teacher layer 325 can receive features from one or more other teacher layers 325 through the internal connections 327. The teacher layer 325, after receiving the features, can aggregate the features with features generated in the teacher layer 325 itself. Features from a teacher layer 325 may an aggregation of features generated in the teacher layer 325 and features received by the teacher layer 325 from one or more other teacher layers 325. For instance, the teacher layer 325D can produce an OFM itself, e.g., through MAC operations of PEs in the teacher layer 325D. The teacher layer 325D also receives features from the teacher layers 324A-325C: the teacher layer 325D may receive an OFM from the teacher layer 325A, an aggregated feature map (AFM) from the teacher layer 325B, and an AFM from the teacher layer 325C. The AFM from the teacher layer 325B may be a result of aggregating the OFM from the teacher layer 325A and an OFM generated in the teacher layer 325B. Similarly, the AFM from the teacher layer 325C may be a result of aggregating the AFM from the teacher layer 325B and an OFM generated in the teacher layer 325C. In some embodiments, the teacher layers 325 have the same feature dimension, e.g., same OFM dimension. That can enable application of internal connections to any layers of the teacher network 320, and the generation of the teacher network 320 can be parameter-free.

Given a stack of L layers and their corresponding output features Ø_{T}_{₁}, . . . , Ø_{T}_{_{L}}, the AFM \hat{Ø}_{T}_{_{L}} of the L-th layer (L>1) can be computed as:

$${\hat{∅}}_{{T}_{L}} = {∅}_{{T}_{L}} + {\hat{∅}}_{{T}_{L - 1}} + … + {\hat{∅}}_{{T}_{1}} = {∅}_{{T}_{L}} + {\sum }_{i = 1}^{L - 1} {\hat{∅}}_{{T}_{i}}$$

where Ø_{T}_{_{L}} is an OFM generated in the L-th teacher layer 325 (e.g., the L-th teacher layer 325 applies a filter onto an IFM and produces the OFM), and \hat{Ø}_{T}_{ᵢ} is the AFM received from the i-th teacher layer 325 (i.e., through an internal connection 327 from the i-th teacher layer 325 to the L-th teacher layer 325). For the teacher layer 325A, which does not receive features from other teacher layers 325:

$${\hat{∅}}_{{T}_{1}} = {∅}_{{T}_{1}}$$

### Example Merged Network

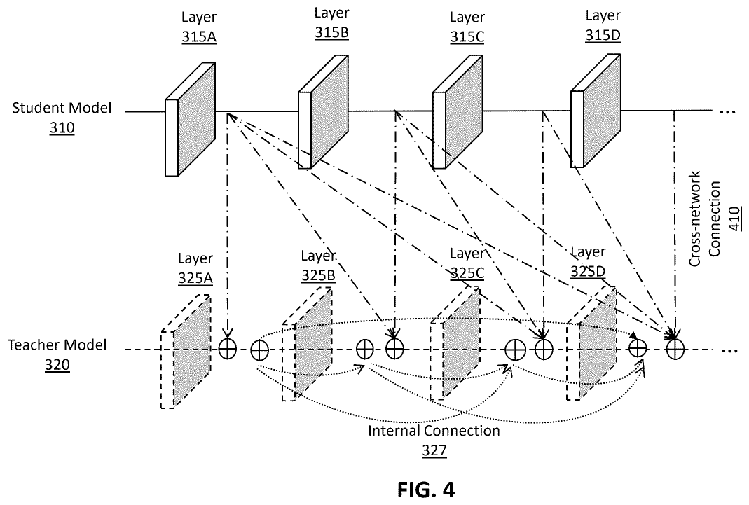

FIG. 4 illustrates merging the student network 310 with the teacher network 320, in accordance with various embodiments. The merging may be done by the merging module 250 in FIG. 2. As shown in FIG. 4, a series of cross-network connections 410 (individually referred to as “cross-network connection 410”) are formed between the student network 310 and the teacher network 320. The cross-network connections 410 connects the student network 310 to the teacher network 320 can facilitate data transfer from the student network 310 to the teacher network 320. As shown in FIG. 4, each cross-network connection 410 provides a data transfer route from a student layer 315 to a teacher layer 325. A student layer 315 is connected to its corresponding teacher layer 325 and every teacher layer 325 after its corresponding teacher layer 325. For instance, the student layer 315A is connected to the teacher layer 325A, which corresponds to the student layer 315A, and the teacher layers 325B-325D, which are teacher layers 325 subsequent to the teacher layer 325A. Similarly, the student layer 315B is connected to the teacher layers 325B-325D, but not connected to the teacher layer 325A. The student layer 315C is connected to the teacher layers 325C and 325D. The student layer 315C is connected to the teacher layer 325D but not connected to the other teacher layers 325A-325C.

A teacher layer 325 may receive an OFM of a student layer 315 through the cross-network connection 410A between the teacher layer 325 and student layer 315. As described above, the teacher layer 325 may also receive AFM(s) (or OFM) from other teacher layers 325 through the internal connections 327. Also, the teacher layer 325 can generate an OFM itself. The teacher layer 325 can aggregate its own OFM, AFMs (or OFM) received from other teacher layers 325, and OFMs received from student layers 315 and produce an AFM of the teacher layer 325. The AFM may be transmitted to another teacher layer 325, e.g., a subsequent teacher layer 325, and the subsequent teacher layer 325 can perform further aggregation of features.

The AFM at the L-th teacher layer 325 (L>1) after merging can be computed as:

$${\hat{∅}}_{{T}_{L}} = {∅}_{{T}_{L}} + {\hat{∅}}_{{T}_{L - 1}} + … + {\hat{∅}}_{{T}_{1}} + {∅}_{{S}_{L}} + … + {∅}_{{S}_{1}} = {∅}_{{T}_{L}} + {\sum }_{i = 1}^{L - 1} {\hat{∅}}_{{T}_{i}} + {\sum }_{i = 1}^{L - 1} {∅}_{{S}_{i}}$$

where Ø_{T}_{_{L}} is the OFM of the L-th teacher layer 325, \hat{Ø}_{T}_{ᵢ} is the AFM of the i-th teacher layer that is received through an internal connection 327, and Ø_{S}_{_{L}} is the OFM of the L-th student layer 315 that is received through a cross-network connection 410. With the cross-network connections 410, feature similarity (e.g., layer-level feature similarity) between the student network 310 and teacher network 320 are enhanced, e.g., due to dense backward gradient flows from the teacher network 320 to the student network 310.

### Example Training of Merged Network

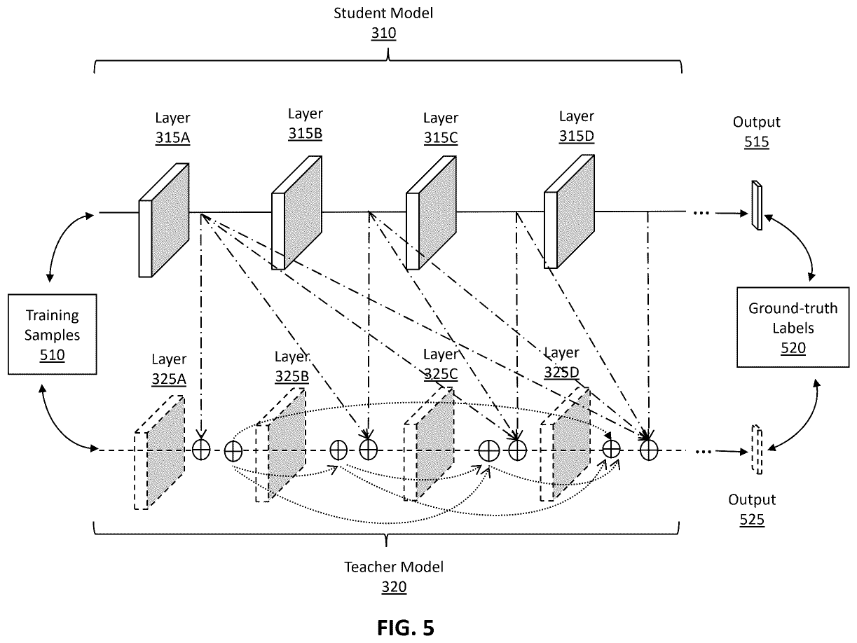

FIG. 5 illustrates training a merged network, in accordance with various embodiments. The merged network includes the student network 310, the teacher network 320, and the cross-network connections 410. The training may be done by the training module 260 in FIG. 2. As shown in FIG. 5, training samples 510 are input into the student network 310 and the teacher network 320. The student network 310 produces an output 515. The teacher network 320 produces an output 525. In some embodiments, the output 515 or 525 may be a prediction, a classification, a determination, or other types of solutions to a problem or questions. Parameters in the merged network are adjusted during the training to optimize the outputs 515 and 525 by minimizing errors in the outputs 515 and 525. The errors may be determined by comparing the outputs 515 and 525 against the ground-truth labels 520 of the training samples 510. The ground-truth labels 520 and the training samples 510 may be included in a training dataset that is formed by the training set generator 220 in FIG. 2.

A loss function, such as a cross-entropy loss function, can be used to adjust the parameters in the merged network. The training module 260 may minimize the error based on a joint optimization objective, e.g., an objective for optimizing both the output of the teacher network and the output of the student network. An example of a joint optimization objective can be represented by the following algorithm:

$$L = {L}_{CE} ( {θ}_{S} , x ) + {L}_{CE} ( \{ {θ}_{S} , {θ}_{T} \} , x )$$

where x is training data, θ_{S} denotes parameters for the student network, θ_{T} denotes parameters for the teacher network, L_{CE} is cross-entropy loss computed on the training data x, and L denotes a joint loss for the merged network. The training module 260 may adjust the parameters (e.g., θ_{S} and θ_{T}) to minimize the joint loss L.

In other embodiments, the training module 260 may facilitate bi-directional distillation, e.g., the student network can benefit from knowledge distilled from the teacher network and the teacher network can benefit from knowledge distilled from the student network. The optimization objective for training with bi-directional distillation may be defined as:

$${L}^{†} = L + {D}_{kl} ( p ( {θ}_{S} , x ) , p ( \{ {θ}_{S} , {θ}_{T} \} , x ) + {D}_{kl} ( p ( \{ {θ}_{S} , {θ}_{T} \} ) , p ( {θ}_{S} , x )$$

where x is training data, θ_{S} denotes parameters for the student network, θ_{T} denotes parameters for the teacher network, L is the joint loss in the algorithm above, p denotes probability distribution, Dₖₗ denotes the Kullback-Leibler divergence, and L^{†} denotes the joint loss for the bi-directional distillation training. The training module 260 may adjust the parameters (e.g., θ_{S} and θ_{T}) to minimize the joint loss L^{†}.

### Example DL Environment

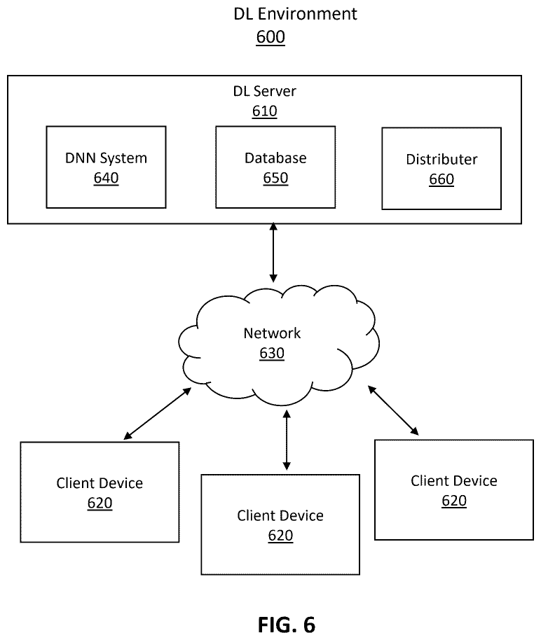

FIG. 6 illustrates a DL environment 600, in accordance with various embodiments. The DL environment 600 includes a DL server 610 and a plurality of client devices 620 (individually referred to as client device 620). The DL server 610 is connected to the client devices 620 through a network 630. In other embodiments, the DL environment 600 may include fewer, more, or different components.

The DL server 610 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 610 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 610 may build DL models specific to particular types of problems that need to be solved. A DL model is trained to receive an input and outputs the solution to the particular problem.

In FIG. 6, the DL server 610 includes a DNN system 640, a database 650, and a distributer 660. The DNN system 640 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1 or the student network 310 described above in conjunction with FIGS. 3-5. In some embodiments, the DNN system 640 trains DNNs through knowledge distillation, e.g., dense-connection based knowledge distillation. The trained DNNs may be used on low memory systems, like mobile phones, IoT edge devices, and so on. An embodiment of the DNN system 640 is the DNN system 200 described above in conjunction with FIG. 2.

The database 650 stores data received, used, generated, or otherwise associated with the DL server 610. For example, the database 650 stores a training dataset that the DNN system 640 uses to train DNNs. In an embodiment, the training dataset is an image gallery that can be used to train a DNN for classifying images. The training dataset may include data received from the client devices 620. As another example, the database 650 stores hyperparameters of the neural networks built by the DL server 610.

The distributer 660 distributes DL models generated by the DL server 610 to the client devices 620. In some embodiments, the distributer 660 receives a request for a DNN from a client device 620 through the network 630. The request may include a description of a problem that the client device 620 needs to solve. The request may also include information of the client device 620, such as information describing available computing resource on the client device. The information describing available computing resource on the client device 620 can be information indicating network bandwidth, information indicating available memory size, information indicating processing power of the client device 620, and so on. In an embodiment, the distributer may instruct the DNN system 640 to generate a DNN in accordance with the request. The DNN system 640 may generate a DNN based on the information in the request. For instance, the DNN system 640 can determine the structure of the DNN and/or train the DNN in accordance with the request.

In another embodiment, the distributer 660 may select the DNN from a group of pre-existing DNNs based on the request. The distributer 660 may select a DNN for a particular client device 630 based on the size of the DNN and available resources of the client device 630. In embodiments where the distributer 660 determines that the client device 630 has limited memory or processing power, the distributer 660 may select a compressed DNN for the client device 630, as opposed to an uncompressed DNN that has a larger size. The distributer 660 then transmits the DNN generated or selected for the client device 620 to the client device 620.

In some embodiments, the distributer 660 may receive feedback from the client device 620. For example, the distributer 660 receives new training data from the client device 620 and may send the new training data to the DNN system 640 for further training the DNN. As another example, the feedback includes an update of the available computer resource on the client device 620. The distributer 660 may send a different DNN to the client device 620 based on the update. For instance, after receiving the feedback indicating that the computing resources of the client device 620 have been reduced, the distributer 660 sends a DNN of a smaller size to the client device 620.

The client devices 620 receive DNNs from the distributer 660 and applies the DNNs to perform machine learning tasks, e.g., to solve problems or answer questions. In various embodiments, the client devices 620 input images into the DNNs and uses the output of the DNNs for various applications, e.g., visual reconstruction, augmented reality, robot localization and navigation, medical diagnosis, weather prediction, and so on. A client device 620 may be one or more computing devices capable of receiving user input as well as transmitting and/or receiving data via the network 630. In one embodiment, a client device 620 is a conventional computer system, such as a desktop or a laptop computer. Alternatively, a client device 620 may be a device having computer functionality, such as a personal digital assistant (PDA), a mobile telephone, a smartphone, an autonomous vehicle, or another suitable device. A client device 620 is configured to communicate via the network 630. In one embodiment, a client device 620 executes an application allowing a user of the client device 620 to interact with the DL server 610 (e.g., the distributer 660 of the DL server 610). The client device 620 may request DNNs or send feedback to the distributer 660 through the application. For example, a client device 620 executes a browser application to enable interaction between the client device 620 and the DL server 610 via the network 630. In another embodiment, a client device 620 interacts with the DL server 610 through an application programming interface (API) running on a native operating system of the client device 620, such as IOS® or ANDROID™.

In an embodiment, a client device 620 is an integrated computing device that operates as a standalone network-enabled device. For example, the client device 620 includes display, speakers, microphone, camera, and input device. In another embodiment, a client device 620 is a computing device for coupling to an external media device such as a television or other external display and/or audio output system. In this embodiment, the client device 620 may couple to the external media device via a wireless interface or wired interface (e.g., an HDMI cable) and may utilize various functions of the external media device such as its display, speakers, microphone, camera, and input devices. Here, the client device 620 may be configured to be compatible with a generic external media device that does not have specialized software, firmware, or hardware specifically for interacting with the client device 620.

The network 630 supports communications between the DL server 610 and client devices 620. The network 630 may comprise any combination of local area and/or wide area networks, using both wired and/or wireless communication systems. In one embodiment, the network 630 may use standard communications technologies and/or protocols. For example, the network 630 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 630 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 630 may be represented using any suitable format, such as hypertext markup language (HTML) or extensible markup language (XML). In some embodiments, all or some of the communication links of the network 630 may be encrypted using any suitable technique or techniques.

### Example Method of Training Neural Network

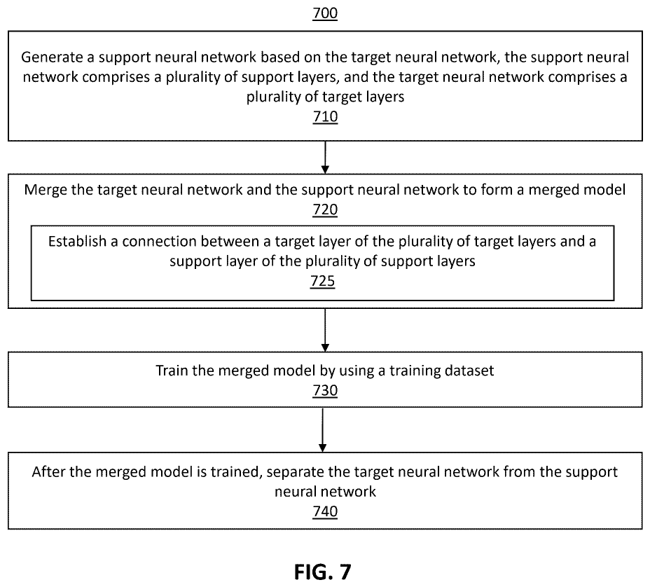

FIG. 7 is a flowchart showing a method 700 of training a DNN through dense-connection based knowledge distillation, in accordance with various embodiments. The method 700 may be performed by the DNN system 200 in FIG. 2. Although the method 700 is described with reference to the flowchart illustrated in FIG. 7, many other methods for training a DNN through dense-connection based knowledge distillation may alternatively be used. For example, the order of execution of the steps in FIG. 7 may be changed. As another example, some of the steps may be changed, eliminated, or combined.

The DNN system 200 generates 710 a support neural network based on the target neural network. The support neural network may be a teacher network, such as the teacher network 320 in FIG. 3. The target neural network may be a student network, such as the student network 310 in FIG. 3. The support neural network comprises a plurality of support layers. The target neural network comprises a plurality of target layers. The DNN system 200 may generate each respective support layer of the plurality of support layers based on a respective target layer of the plurality of target layers. The respective support layer and the respective target layer may each include a same number of PEs arranged in a same structure. The PEs are configured to perform multiply-accumulate operations. The plurality of support layers may align with the plurality of target layers.

The DNN system 200 may also generate an internal connection within the support neural network. The internal connection is from a first support layer to a second support layer, the second support layer may be configured to receive a first feature map from the first support layer, generate a second feature map, and aggregate the first feature map and the second feature map. In some embodiments, the DNN system 200 generates multiple internal connections that connects a support layer to multiple other support layers. For instance, the DNN system 200 generates an additional internal connection within the support neural network, wherein the additional internal connection is from a third support layer to the second support layer. The second support layer may receive a first feature map from the first support layer, receive a third feature map from the third support layer, generate a second feature map, and aggregate the first feature map, the second feature map, and the third feature map.

The DNN system 200 merges 720 the target neural network and the support neural network to form a merged model. Merging the target neural network and the support neural network comprises establishing 725 a connection between a target layer of the plurality of target layers and a support layer of the plurality of support layers. The connection is to be used to transfer data between the target layer and the support layer. In some embodiments, the DNN system 200 forms multiple connections (e.g., the cross-network connections 410 in FIG. 4) between the target neural network and the support neural network. The connection may be from the support layer to the target layer. The support layer can receive a first feature map from the target layer, generate a second feature map, and aggregate the first feature map with the second feature map. Alternatively, the connection may be bi-directional. The DNN system 200 may establish another connection between the target layer and another support layer of the plurality of support layers.

The DNN system 200 trains 730 the merged model by using a training dataset. In some embodiments, the DNN system 200 inputs training samples in the training dataset into the target neural network, and the target neural network generates a target output. The DNN system 200 also inputs the training samples into the support neural network, and the support neural network generates a support output. The DNN system 200 adjusts parameters of the target neural network and the support neural network based on ground-truth labels in the training dataset, the target output, and the support output.

After the merged model is trained, the DNN system 200 separates 740 the target neural network from the support neural network. For instance, the DNN system 200 may remove the connections that connects the target neural network to the support neural network. In some embodiments, the support neural network may not be detachable. The target neural network, after separated, can be used to perform machine learning tasks, e.g., to solve problems or answer questions by running available data through inferences.

### Example Computing Device

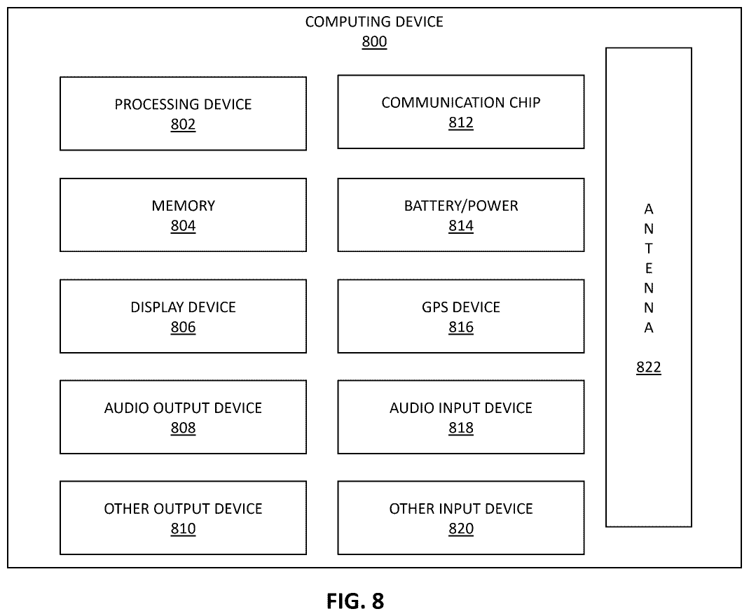

FIG. 8 is a block diagram of an example computing device 800, in accordance with various embodiments. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include an audio input device 818 or an audio output device 808, but may include audio input or output device interface circuitry (e.g., connectors and supporting circuitry) to which an audio input device 818 or audio output device 808 may be coupled.

The computing device 800 may include a processing device 802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 802 may include one or more digital signal processors (DSPs), application-specific ICs (ASICs), CPUs, GPUs, cryptoprocessors (specialized processors that execute cryptographic algorithms within hardware), server processors, or any other suitable processing devices. The computing device 800 may include a memory 804, which may itself include one or more memory devices such as volatile memory (e.g., DRAM), nonvolatile memory (e.g., read-only memory (ROM)), flash memory, solid state memory, and/or a hard drive. In some embodiments, the memory 804 may include memory that shares a die with the processing device 802. In some embodiments, the memory 804 includes one or more non-transitory computer-readable media storing instructions executable to perform operations for training DNNs through dense-connection based knowledge distillation, e.g., the method 700 described above in conjunction with FIG. 7 or the operations performed by the DNN system 200 described above in conjunction with FIG. 2. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.13 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 812 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include an other output device 813 (or corresponding interface circuitry, as discussed above). Examples of the other output device 813 may include an audio codec, a video codec, a printer, a wired or wireless transmitter for providing information to other devices, or an additional storage device.

The computing device 800 may include an other input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 800 may be any other electronic device that processes data.

### Select Examples

The following paragraphs provide various examples of the embodiments disclosed herein.

Example 1 provides a method for training a target neural network, the method including generating a support neural network based on the target neural network, where the support neural network includes a plurality of support layers, and the target neural network includes a plurality of target layers; merging the target neural network and the support neural network to form a merged network, where merging the target neural network and the support neural network includes establishing a connection between a target layer of the plurality of target layers and a support layer of the plurality of support layers, the connection to be used to transfer data between the target layer and the support layer; training the merged network by using a training dataset; and after the merged network is trained, separating the target neural network from the support neural network.

Example 2 provides the method of example 1, where generating the support neural network based on the target neural network includes generating each respective support layer of the plurality of support layers based on a respective target layer of the plurality of target layers.

Example 3 provides the method of example 2, where the respective support layer and the respective target layer each includes PEs arranged in a same structure, the PEs configured to perform multiply-accumulate operations.

Example 4 provides the method of example 1, where generating the support neural network includes generating an internal connection within the support neural network, where the internal connection is from a first support layer to a second support layer.

Example 5 provides the method of example 4, where the second support layer is configured to receive a first feature map from the first support layer through the internal connection; generate a second feature map; and aggregate the first feature map and the second feature map.

Example 6 provides the method of example 4, where generating the support neural network further includes generating an additional internal connection within the support neural network, where the additional internal connection is from a third support layer to the second support layer.

Example 7 provides the method of example 6, where the second support layer is configured to receive a first feature map from the first support layer through the internal connection; receive a third feature map from the third support layer through the additional internal connection; generate a second feature map; and aggregate the first feature map, the second feature map, and the third feature map.

Example 8 provides the method of example 1, where the connection is from the support layer to the target layer, and the support layer is configured to receive a first feature map from the target layer through the connection, generate a second feature map, and aggregate the first feature map with the second feature map.

Example 9 provides the method of example 1, where merging the target neural network and the support neural network further includes establishing another connection between the target layer and another support layer of the plurality of support layers.

Example 10 provides the method of example 1, where training the merged network by using the training dataset includes inputting training samples in the training dataset into the target neural network, the target neural network generating a target output; inputting the training samples into the support neural network, the support neural network generating a support output; and adjusting parameters of the target neural network and the support neural network based on ground-truth labels in the training dataset, the target output, and the support output.

Example 11 provides one or more non-transitory computer-readable media storing instructions executable to perform operations for training a target neural network, the operations including generating a support neural network based on the target neural network, where the support neural network includes a plurality of support layers, and the target neural network includes a plurality of target layers; merging the target neural network and the support neural network to form a merged network, where merging the target neural network and the support neural network includes establishing a connection between a target layer of the plurality of target layers and a support layer of the plurality of support layers, the connection to be used to transfer data between the target layer and the support layer; training the merged network by using a training dataset; and after the merged network is trained, separating the target neural network from the support neural network.

Example 12 provides the one or more non-transitory computer-readable media of example 11, where generating the support neural network based on the target neural network includes generating each respective support layer of the plurality of support layers based on a respective target layer of the plurality of target layers.

Example 13 provides the one or more non-transitory computer-readable media of example 12, where the respective support layer and the respective target layer each includes PEs arranged in a same structure, the PEs configured to perform multiply-accumulate operations.

Example 14 provides the one or more non-transitory computer-readable media of example 11, where generating the support neural network includes generating an internal connection within the support neural network, where the internal connection is from a first support layer to a second support layer.

Example 15 provides the one or more non-transitory computer-readable media of example 14, where the second support layer is configured to receive a first feature map from the first support layer through the internal connection; generate a second feature map; and aggregate the first feature map and the second feature map.

Example 16 provides the one or more non-transitory computer-readable media of example 14, where generating the support neural network further includes generating an additional internal connection within the support neural network, where the additional internal connection is from a third support layer to the second support layer.

Example 17 provides the one or more non-transitory computer-readable media of example 16, where the second support layer is configured to receive a first feature map from the first support layer through the internal connection; receive a third feature map from the third support layer through the additional internal connection; generate a second feature map; and aggregate the first feature map, the second feature map, and the third feature map.

Example 18 provides the one or more non-transitory computer-readable media of example 11, where the connection is from the support layer to the target layer, and the support layer is configured to receive a first feature map from the target layer through the connection, generate a second feature map, and aggregate the first feature map with the second feature map.

Example 19 provides the one or more non-transitory computer-readable media of example 11, where merging the target neural network and the support neural network further includes establishing another connection between the target layer and another support layer of the plurality of support layers.

Example 20 provides the one or more non-transitory computer-readable media of example 11, where training the merged network by using the training dataset includes inputting training samples in the training dataset into the target neural network, the target neural network generating a target output; inputting the training samples into the support neural network, the support neural network generating a support output; and adjusting parameters of the target neural network and the support neural network based on ground-truth labels in the training dataset, the target output, and the support output.

Example 21 provides an apparatus for training a target neural network, the apparatus including: a computer processor for executing computer program instructions; and a non-transitory computer-readable memory storing computer program instructions executable by the computer processor to perform operations including generating a support neural network based on the target neural network, where the support neural network includes a plurality of support layers, and the target neural network includes a plurality of target layers, merging the target neural network and the support neural network to form a merged network, where merging the target neural network and the support neural network includes establishing a connection between a target layer of the plurality of target layers and a support layer of the plurality of support layers, the connection to be used to transfer data between the target layer and the support layer, training the merged network by using a training dataset, and after the merged network is trained, separating the target neural network from the support neural network.

Example 22 provides the apparatus of example 21, where generating the support neural network based on the target neural network includes generating each respective support layer of the plurality of support layers based on a respective target layer of the plurality of target layers.

Example 23 provides the apparatus of example 21, where generating the support neural network includes generating an internal connection within the support neural network, where the internal connection is from a first support layer to a second support layer.

Example 24 provides the apparatus of example 21, where the connection is from the support layer to the target layer, and the support layer is configured to receive a first feature map from the target layer through the connection, generate a second feature map, and aggregate the first feature map with the second feature map.

Example 25 provides the apparatus of example 21, where training the merged network by using the training dataset includes inputting training samples in the training dataset into the target neural network, the target neural network generating a target output; inputting the training samples into the support neural network, the support neural network generating a support output; and adjusting parameters of the target neural network and the support neural network based on ground-truth labels in the training dataset, the target output, and the support output.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for training a target neural network, the method comprising:
generating a support neural network based on the target neural network, wherein the support neural network comprises a plurality of support layers, and the target neural network comprises a plurality of target layers;
merging the target neural network and the support neural network to form a merged network, wherein merging the target neural network and the support neural network comprises:
establishing a connection between a target layer of the plurality of target layers and a support layer of the plurality of support layers, the connection to transfer data between the target layer and the support layer;
training the merged network by using a training dataset; and
after the merged network is trained, separating the target neural network from the support neural network.

2. The method of claim 1, wherein generating the support neural network based on the target neural network comprises:
generating each respective support layer of the plurality of support layers based on a respective target layer of the plurality of target layers.

3. The method of claim 2, wherein the respective support layer and the respective target layer each includes processing elements arranged in a same structure, the processing elements configured to perform multiply-accumulate operations.

4. The method of claim 1, wherein generating the support neural network comprises:
generating an internal connection within the support neural network, wherein the internal connection is from a first support layer to a second support layer.

5. The method of claim 4, wherein the second support layer is configured to:
receive a first feature map from the first support layer;
generate a second feature map; and
aggregate the first feature map and the second feature map.

6. The method of claim 4, wherein generating the support neural network further comprises:
generating an additional internal connection within the support neural network, wherein the additional internal connection is from a third support layer to the second support layer.

7. The method of claim 6, wherein the second support layer is configured to:
receive a first feature map from the first support layer;
receive a third feature map from the third support layer;
generate a second feature map; and
aggregate the first feature map, the second feature map, and the third feature map.

8. The method of claim 1, wherein the connection is from the support layer to the target layer, and the support layer is configured to:
receive a first feature map from the target layer,
generate a second feature map, and
aggregate the first feature map with the second feature map.

9. The method of claim 1, wherein merging the target neural network and the support neural network further comprises establishing another connection between the target layer and another support layer of the plurality of support layers.

10. The method of claim 1, wherein training the merged network by using the training dataset comprises:
inputting training samples in the training dataset into the target neural network, the target neural network generating a target output;
inputting the training samples into the support neural network, the support neural network generating a support output; and
adjusting parameters of the target neural network and the support neural network based on ground-truth labels in the training dataset, the target output, and the support output.

11. One or more non-transitory computer-readable media storing instructions executable to perform operations for training a target neural network, the operations comprising:
generating a support neural network based on the target neural network, wherein the support neural network comprises a plurality of support layers, and the target neural network comprises a plurality of target layers;
merging the target neural network and the support neural network to form a merged network, wherein merging the target neural network and the support neural network comprises:
establishing a connection between a target layer of the plurality of target layers and a support layer of the plurality of support layers, the connection to transfer data between the target layer and the support layer;
training the merged network by using a training dataset; and
after the merged network is trained, separating the target neural network from the support neural network.

12. The one or more non-transitory computer-readable media of claim 11, wherein generating the support neural network based on the target neural network comprises:
generating each respective support layer of the plurality of support layers based on a respective target layer of the plurality of target layers.

13. The one or more non-transitory computer-readable media of claim 12, wherein the respective support layer and the respective target layer each includes processing elements arranged in a same structure, the processing elements configured to perform multiply-accumulate operations.

14. The one or more non-transitory computer-readable media of claim 11, wherein generating the support neural network comprises:
generating an internal connection within the support neural network, wherein the internal connection is from a first support layer to a second support layer.

15-17. (canceled)

18. The one or more non-transitory computer-readable media of claim 11, wherein the connection is from the support layer to the target layer, and the support layer is configured to:
receive a first feature map from the target layer,
generate a second feature map, and
aggregate the first feature map with the second feature map.

19. The one or more non-transitory computer-readable media of claim 11, wherein merging the target neural network and the support neural network further comprises establishing another connection between the target layer and another support layer of the plurality of support layers.

20. The one or more non-transitory computer-readable media of claim 11, wherein training the merged network by using the training dataset comprises:
inputting training samples in the training dataset into the target neural network, the target neural network generating a target output;
inputting the training samples into the support neural network, the support neural network generating a support output; and
adjusting parameters of the target neural network and the support neural network based on ground-truth labels in the training dataset, the target output, and the support output.

21. An apparatus for training a target neural network, the apparatus comprising:
a computer processor for executing computer program instructions; and
a non-transitory computer-readable memory storing computer program instructions executable by the computer processor to perform operations comprising:
generating a support neural network based on the target neural network, wherein the support neural network comprises a plurality of support layers, and the target neural network comprises a plurality of target layers,
merging the target neural network and the support neural network to form a merged network, wherein merging the target neural network and the support neural network comprises:
establishing a connection between a target layer of the plurality of target layers and a support layer of the plurality of support layers, the connection to transfer data between the target layer and the support layer,
training the merged network by using a training dataset, and
after the merged network is trained, separating the target neural network from the support neural network.

22. (canceled)

23. The apparatus of claim 21, wherein generating the support neural network comprises:
generating an internal connection within the support neural network, wherein the internal connection is from a first support layer to a second support layer.

24. The apparatus of claim 21, wherein the connection is from the support layer to the target layer, and the support layer is configured to:
receive a first feature map from the target layer,
generate a second feature map, and
aggregate the first feature map with the second feature map.

25. (canceled)
